(19) United States
(12) Patent Application Publication
(10) Pub. No.: US 2008/0047347 A1
(43) Pub. Date: Feb. 28, 2008

(54) ULTRASONIC STRESS MEASURING APPARATUS

(75) Inventors: Michio Sato, Yokosuka-Shi (JP); Kazumi Watanabe, Tokyo (JP); Masayuki Asano, Yokohama-Shi (JP); Rie Sumiya, Yokohama-Shi (JP); Masaaki Kikuchi, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/843,375

(22) Filed: Aug. 22, 2007

(30) Foreign Application Priority Data
Aug. 24, 2006 (JP) 2006-227971

(51) Int. Cl. G01H 5/00

(52) U.S. Cl. 73/597

(57) ABSTRACT

After a probe control means causes a longitudinal wave probe to carry out transmission and reception, it slides a shear wave probe to the same position. The probe control means rotates the shear wave probe at each predetermined angle and rotates it 180° while causing it to carry out the transmission and the reception at each rotating position. A measured data analyzer 16 calculates the constant of texture induced anisotropy in a test piece from echo data when both the probes carry out the transmission and the reception. With this arrangement, it is possible to measure the residual stress of a material, in which both texture induced anisotropy and residual stress induced anisotropy mixedly exist with pinpoint accuracy by separating only the texture induced anisotropy from the material.

### BACKGROUND OF THE INVENTION

1. Field of the Invention

The present invention relates to an ultrasonic stress measuring apparatus used to a technology for diagnosing material deterioration and the like.

2. Related Art

The role of a material deterioration diagnosis apparatus has become important as a planning maintenance technology of a nuclear power plant. This is because it is increasingly required to measure a residual stress, which is one of the reasons for causing a fatigue crack and a stress corrosion crack of the structures and the pipings in a reactor and to improve a stress as a countermeasure for preventing them.

A strain gauge is a simplest device as a residual stress measuring means. However, since the strain gauge requires to cut and to take out a part of a to-be-measured structure as a test piece, it is difficult to use it to measure a residual stress in a job site.

Accordingly, it is considered to use an X-ray stress measuring apparatus using an X-ray diffraction technology as a residual stress measuring means which does not require to cut out a test piece. The X-ray stress measuring apparatus calculates a residual stress value making use of Bragg diffraction on a surface of a test piece. However, since the X-ray stress measuring apparatus uses an X-ray, background noise is increased in a radioactive environment such as in the nuclear power plant, and thus the X-ray stress measuring apparatus has a drawback in that a signal sufficient to measure a residual stress accurately cannot be obtained.

In contrast, since an ultrasonic stress measuring apparatus can measure stress by only applying an ultrasonic sensor onto a surface of a test piece as a target to be measured, it is not necessary to cut out a test piece as a to-be measured body from a structure. Further, since an ultrasonic signal is used, a less amount background noise is generated even in the radioactive environment such as in the nuclear power plant, thereby a stress can be easily measured.

Because of the reasons as described above, many ultrasonic stress measuring apparatuses are conventionally proposed. In a stress measurement material, a residual stress on a surface of the material is more important than that in the material as a residual stress to be measured. This is because one of the reasons of the stress corrosion crack is a tensile stress on the material surface.

As to the measurement of a residual stress on a material surface, “Latest Stress-Strain Measurement And Evaluation Technology” edited by Kozou Kawada, pp. 316-317, Published by Kabushiki Kaisha Sougou Gijutu Center discloses acoustoelastic law using a surface acoustic wave (SAW). The acoustoelastic law is as shown below.

That is, when the rolling direction of a steel sheet is shown by an X-axis, a direction orthogonal to the rolling direction is shown by a Y-axis, the relation between the sound velocity V_{R} (θ) of an SAW, which travels in a direction having an angle θ (°) to the X-axis and a stress is as described below.

$${V}_{R} ( θ ) = {V}_{R}^{0} [ 1 + {α}_{R} ( θ ) + \frac{1}{2} \{ {C}_{R} ( {σ}_{X} + {σ}_{Y} ) + {C}_{AR} ( {σ}_{X} - {σ}_{Y} ) cos 2 θ \} ] \qquad ( 1 )$$

where,
V_{R}⁰: sound velocity of SAW(m/sec) in isotropic body whose residual stress is 0
α_{R}(θ): texture induced anisotropy constants in θ direction
σ_{X}: main stress in X direction (MPa)
σ_{Y}: main stress in Y direction (MPa)
C_{R}, C_{AR}: acoustic elastic constants (1/MPa)
   According to the expression (1), it can be found that the acoustic anisotropy includes two acoustic anisotropies, that is, a texture induced anisotropy of a material and an acoustic anisotropy due to a residual stress. In the case of a stress in a single axis direction, since θ=0 from “Latest Stress-Strain Measurement And Evaluation Technology” edited by Kozou Kawada, pp. 316-317, Published by Kabushiki Kaisha Sougou Gijutu Center, an expression (2) is established.
   V_{R}(0)=V_{R}⁰[1+α_{R}(0)+K_{R1}σ] (2)
   where, σ_{X}=σ, σ_{Y}=0, C_{R}=K_{R1}+K_{R2}, C_{AR}=K_{R1}−K_{R2}

According to “Latest Stress-Strain Measurement And Evaluation Technology” edited by Kozou Kawada, pp. 316-317, Published by Kabushiki Kaisha Sougou Gijutu Center, when a tensile test is carried out, the following values are obtained in a steel material (ANSI 4130).
K_{R1}=−1.14×10⁻⁶ (1/MPa), K_{R1}=0.63×10⁻⁶ (1/MPa)

However, since the constant α_{R}(0) of texture induced anisotropy is unknown in the method according to “Latest Stress-Strain Measurement And Evaluation Technology” edited by Kozou Kawada, pp. 316-317, Published by Kabushiki Kaisha Sougou Gijutu Center, a residual stress value (σ) itself cannot be measured even if the ratio of change of an SAW sound velocity to a stress value can be measured. Accordingly, when it is intended to measure a residual stress, it is indispensable to determine the texture induced anisotropy constant.

JIS Z 3060: 2002 and a publication according to Japanese Patent Application Laid-Open Publication (JP-A) No. 2005-36295 based on it disclose a method of determining a scanning angle range in consideration of acoustic anisotropy. That is, the ratio (V/V_{STB}) of the sound velocity (V) of a test piece and the sound velocity (V_{STB}) of a JIS standard test piece is measured and defined as an STB sound velocity ratio. Then, the range of a refraction angle used to scanning is determined according to the thickness of the test piece and the STB sound velocity ratio.

However, what is determined by JIS Z 3060: 2002 and JP-A No. 2005-36295 is a prescription when a longitudinal wave and a shear wave are caused to travel in the interior of a test piece and nothing is prescribed as to the texture induced anisotropy of an SAW necessary to calculate the residual stress value of a material surface.

On the other hand, a method of reducing acoustic anisotropy is proposed in the field of a material manufacturing method. This is because when scanning is carried out at an oblique angle, since the sound velocity of a material is changed depending on acoustic anisotropy, a predetermined refraction angle cannot be obtained and thus the positioning accuracy of a defective part is lowered.

JP-A Nos. 2005-226158, 2004-300567, 2004-225090, 2003-313632 and 2002-180132 are proposed as latest methods of manufacturing a material for lowering the acoustic anisotropy. The methods of measuring acoustic anisotropy shown in JP-A Nos. 2005-226158, 2004-300567, 2004-225090, 2003-313632 and 2002-180132 are generally as described below.

That is, when the main rolling direction of a rolled steel sheet is shown by an L-direction, and a direction orthogonal to the main rolling direction is shown by a C-direction, a shear wave traveling in the thickness direction of the steel sheet includes two shear waves depending on a vibrating direction thereof, and the sound velocity of the shear wave which vibrates in the L-direction is shown by V_{L} (m/sec), and the sound velocity of the shear wave which vibrates in the C-direction is shown by V_{C} (m/sec).

Then, the constant of acoustic anisotropy is defined by V_{L}/V_{C}, and when the constant is equal to or less than 1.02, it is determined that the acoustic anisotropy is small, whereas when the constant exceeds 1.02, it is determined that the acoustic anisotropy is large. However, the constant of acoustic anisotropy defined by the method relates to the shear wave traveling in a material and does not relate to the texture induced anisotropy necessary to measure a surface stress.

Further, JP-A Nos. 2005-77298, 2004-294232, and 2001-249118 disclose methods of presuming the aging of a material by previously measuring the characteristics of a material before it is used and measuring the characteristics thereof after it is used as a method of measuring acoustic anisotropy.

That is, according to the method of JP-A No. 2005-77298, a shear wave is transmitted and received in a material using an electromagnetic ultrasonic probe, the sound velocities V_{L}, V_{C} of two shear waves vibrating in directions orthogonal to each other are measured, and acoustic anisotropy is calculated from the sound velocity ratio of them. Then, the change of the sound velocity ratio is evaluated as the aging of the material.

The method according to JP-A No. 2004-294232 measures the difference between main stresses making use of an SH surface wave. Then, the deterioration of a material is evaluated by observing the aging of the difference between the main stresses.

A method according to JP-A No. 2001-249118 simply monitors the phase difference of a received ultrasonic signal and the change of an sound velocity and evaluates aging from the amounts of change of them.

As described above, the methods according to JP-A Nos. 2005-77298, 2004-294232, and 2001-249118 evaluate the deterioration of a material by previously obtaining the data of a material before it is used, obtaining the data of the material after it is used for a certain period, and comparing both the data. In these methods, since it is a premise that the data of the material before it is used exist, they cannot be applied when the data does not exist.

Further, the methods according to IP-A Nos. 2005-77298, 2004-294232, and 2001-249118 make use of the sound velocity of a shear wave traveling in a test piece and disclose nothing as to the texture induced anisotropy of an SAW of a material surface which is necessary to calculate a residual stress value. On the other hand, since the SH surface wave is used in the method according to JP-A No. 2004-294232, it is possible to measure the difference of main stresses without being affected by texture induced anisotropy of a material. However, the method discloses nothing as to the texture induced anisotropy of an SAW likewise.

“Effect of Acoustic Elasticity of SAW”, Kenichi Okada, Program & Abstracts of Seventh symposium as to Basis and Application of Ultrasonic Wave Electronics, P10, pp. 39 to 40, 1986 discloses a technology for measuring texture induced anisotropy by applying an SAW to a test piece having a less amount of a surface residual stress. However, the technology is based on a premise that a residual stress does not exist when it evaluates texture induced anisotropy. That is, when both texture induced anisotropy and residual stress induced anisotropy mixedly exist, “Effect of Acoustic Elasticity of Surface Wave”, Kenichi Okada, Program & Abstracts of Seventh symposium as to Basis and Application of Ultrasonic Wave Electronics, P10, pp. 39 to 40, 1986 does not disclose a technology for separately determining only texture induced anisotropy.

As described above, when the residual stress of a material is measured making use of an SAW, the texture induced anisotropy of the material must be determined. However, since both texture induced anisotropy and residual stress induced anisotropy are ordinarily mixed, there is not a technology for separately determining only the texture induced anisotropy. Accordingly, it cannot conventionally measure the residual stress of a material with accuracy higher than a predetermined level.

An object of the present invention, which was made in view of the above circumstances, is to provide a technology for separating only texture induced anisotropy from a material in which both texture induced anisotropy and residual stress induced anisotropy mixedly exist and realize an ultrasonic stress measuring apparatus capable of measuring the residual stress of the material by the technology with pinpoint accuracy.

### SUMMARY OF THE INVENTION

As a means for solving the above problems, a first aspect of an ultrasonic stress measuring apparatus of the invention is composed of a longitudinal wave probe and a shear wave probe which can be disposed on a surface of a stress measurement material, a probe drive mechanism capable of moving or rotating both the probes along the surface of the material, and a probe control means for causing one of both the probes to carry out an ultrasonic transmitting/receiving operation to a to-be-measured portion of the material, thereafter switching the disposition of one of the probes and that of the other thereof by controlling the movement of the probe drive mechanism and causing the other probe to carry out an ultrasonic transmitting/receiving operation to the same to-be-measured portion, and, in particular rotating the shear wave probe N times at each rotation angle of 180°/N (N: integer of at least 2) so that the shear wave probe carries out the transmitting/ receiving operation at each rotating position and a measured data analyzing means for determining the constant of texture induced anisotropy from the sound velocity data of the SAW obtained from the transmitting/receiving operations of both the probes and calculating the residual stress of the stress measurement material based on the determined constant.

According to the first aspect of the ultrasonic stress measuring apparatus of the invention, the sound velocity data of the SAW of the second aspect of the invention may be the sound velocity data of an SAW traveling in an X-axis direction without being affected by surface residual stress induced anisotropy, the sound velocity data of an SAW traveling in a Y-axis direction vertical to the X-axis direction without being affected by the surface residual stress induced anisotropy and the sound velocity data of an SAW in an isotropic body which is not affected by any of surface residual stress induced anisotropy and texture induced anisotropy.

According to the second aspect of the ultrasonic stress measuring apparatus, the sound velocity data of the SAW traveling in the X-axis and Y-axis directions of the third aspect of the invention, respectively, may be determined as the solution of a predetermined hexanary SAW sound velocity equation shown using the longitudinal wave velocity and the sound velocities of shear waves in the X-axis and Y-axis directions, and the sound velocity data of the SAW in the isotropic body, which is not affected by any of the surface residual stress induced anisotropy and the texture induced anisotropy, may be determined by calculating the average value of the sound velocity data of N pieces SAW determined as the solution of a predetermined hexanary SAW sound velocity equation shown using the sound velocity of the longitudinal wave and the sound velocity of the shear wave in an ultrasonic traveling direction at the rotating position after the shear wave ultrasonic probe is rotated N times.

According to the second aspect of the ultrasonic stress measuring apparatus, the sound velocity data of the SAW traveling in the X-axis and Y-axis directions of the fourth aspect of the invention, respectively, may be determined from a predetermined equation in which the ratio of the sound velocities of the SAW in the X-axis and Y-axis directions and the acoustic velocities of the shear waves in the X-axis and Y-axis directions is shown by a Poisson ratio and the sound velocity data of the SAW in the isotropic body, which is not affected by any of the surface residual stress induced anisotropy and the texture induced anisotropy, may be determined by calculating the average value of the sound velocity data of N pieces of SAW determined from a predetermined equation in which the sound velocity of an SAW in an ultrasonic traveling direction at the rotating position of the shear wave ultrasonic probe after it is rotated N times and the sound velocity of a shear wave in the same direction is shown by a Poisson's ratio.

According to the second aspect of the ultrasonic stress measuring apparatus, the sound velocity data of an SAW in an isotropic body, which is not affected by any of the surface residual stress induced anisotropy and the texture induced anisotropy of the fifth aspect of the invention, may be determined by calculating the average value of two data, that is, the sound velocity data of the SAW traveling in the X-axis direction without being affected by the surface residual stress induced anisotropy and the sound velocity data of the SAW traveling in the Y-axis direction vertical to the X-axis direction without being affected by the surface residual stress induced anisotropy.

According to the second aspect of the ultrasonic stress measuring apparatus, the sound velocity data of the SAW in the isotropic body, which is not affected by any of the surface residual stress induced anisotropy and the texture induced anisotropy of the sixth aspect of the invention, may be determined by previously obtaining by actually measuring the sound velocity data of N pieces of SAW in an ultrasonic traveling direction at the rotating position of the shear wave ultrasonic probe after it is rotated N times and calculating the average value of the obtained N pieces of data.

According to second aspect of the ultrasonic stress measuring apparatus, the sound velocity data of the SAW of the isotropic body, which is not affected by any of the surface residual stress induced anisotropy and the texture induced anisotropy of the seventh aspect of the invention, may be determined by actually measuring two data, that is, the sound velocity data of the SAW traveling in the X-axis direction without being affected by the surface residual stress induced anisotropy and the sound velocity data of the SAW traveling in the Y-axis direction vertical to the X-axis direction without being affected by the surface residual stress induced anisotropy previously and calculating the average value of the two obtained data.

According to the present invention, the sound velocity data of the respective SAW are calculated by causing both the longitudinal and shear wave probes to carry out a transmission/reception operation to the same to-be-measured portion of a material, and, in particular, causing the shear wave probe to carry out the transmission/reception operation at each of a plurality of times of rotation, it is possible to separate only texture induced anisotropy from the material in which both the texture induced anisotropy and residual stress induced anisotropy mixedly exist. Accordingly, it is possible to provide an ultrasonic stress measuring apparatus capable of measuring the residual stress of a material with pinpoint accuracy.

### BRIEF DESCRIPTION OF THE DRAWINGS

FIG. 1 is an arrangement view of an ultrasonic stress measuring apparatus according to an embodiment of the present invention;

FIG. 2 is a flowchart for explaining an operation of FIG. 1;

Parts (a) and (b) of FIG. 3 are waveform views of echo data collected by a measured data analyzer 16 in FIG. 1, wherein the part (a) shows the multiple echo of a longitudinal wave, and the part (b) shows the multiple echo of a shear wave;

FIG. 4 is an explanatory view showing the contents of a data table in which the data calculated by the measured data analyzer 16 in FIG. 1 is summarized; and

FIG. 5 is an explanatory view showing a test piece M in FIG. 1 and a three-dimensional coordinate set to the test piece M, wherein the part (a) is an explanatory view showing a plane P1 orthogonal to an X-axis by slanting lines, and the part (b) is an explanatory view showing a plane P2 orthogonal to a Y-axis by slanting lines.

### DETAILED DESCRIPTION OF THE INVENTION

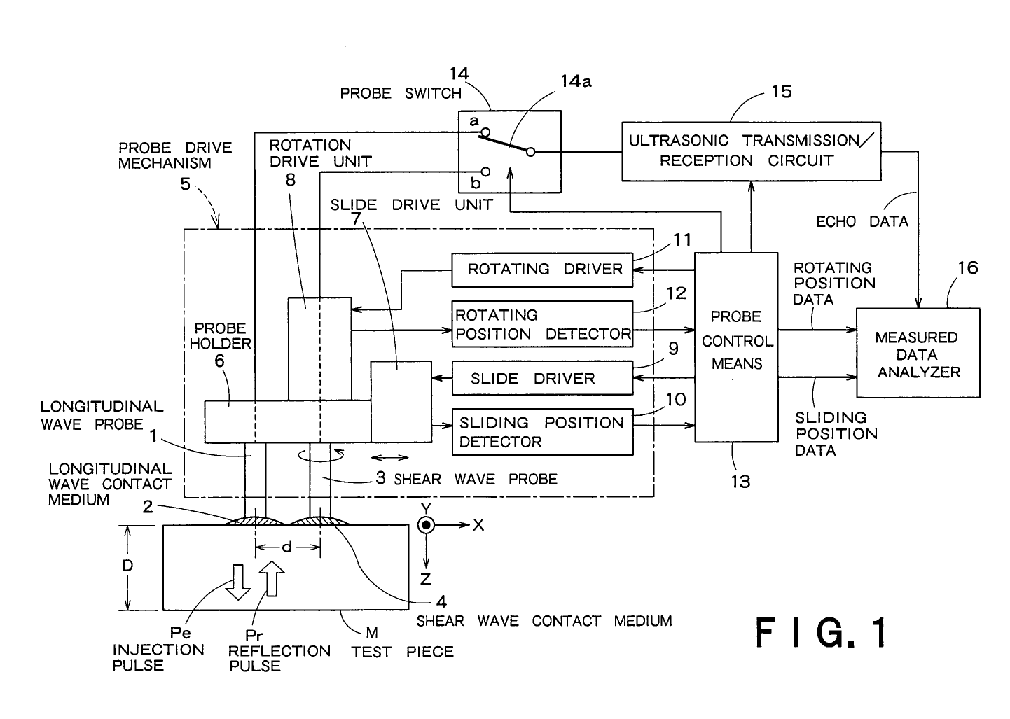

FIG. 1 is an arrangement view of an ultrasonic stress measuring apparatus of an embodiment according to the present invention. An XY coordinate plane is set on a flat surface of a test piece M (stress measurement material) having a thickness D, and the XY coordinate plane has an X-axis and a Y-axis vertical to the X-axis, and a Z-axis is set to the XY coordinate plane in a vertical direction.

One end of a longitudinal wave probe 1 is disposed on a surface of the test piece M through a longitudinal wave contact medium 2, and one end of a shear wave probe 3 is disposed at a position apart from the longitudinal wave ultrasonic probe 1 a distance d through a shear wave contact medium 4.

The longitudinal wave probe 1 and the shear wave probe 3 are driven by a probe drive mechanism 5. That is, the other ends of the longitudinal wave probe 1 and the shear wave probe 3 are supported by a probe holder 6, and a slide drive unit 7 and a rotation drive unit 8 are attached to the probe holder 6.

The slide drive unit 7 slides the probe holder 6 based on a control signal from a slide driver 9 so that the longitudinal wave probe 1 and the shear wave probe 3 can be moved in a horizontal direction along the surface of the test piece M.

The rotation drive unit 8 rotates the probe holder 6 based on a control signal from a rotation driver 11 so that the shear wave probe 3 can be rotated at each predetermined angle along the surface of the test piece M.

The respective slide positions of the longitudinal wave probe 1 and the shear wave probe 3 and the rotating position of the shear wave probe 3 are output to a probe control means 13, respectively by a slide position detector 10 and a rotating position detector 12. Then, the probe control means 13 outputs the sliding position data and the rotating position data to a measured data analyzer 16.

The longitudinal wave probe 1 and the shear wave probe 3 are connected to an ultrasonic transmission/reception circuit 15 through a probe switch 14. The contact positions of the contact 14a of the probe switch 14 with terminals a, b can be switched by the probe control means 13. Then, the ultrasonic transmission/reception circuit 15 causes the longitudinal wave probe 1 or the shear wave probe 3 to carry out an operation for transmitting an injection pulse Pe based on an ultrasonic transmission command from the probe control means 13 as well as causes it to carry out an operation for receiving a reflection pulse Pr and outputs the echo data thereof to the measured data analyzer 16.

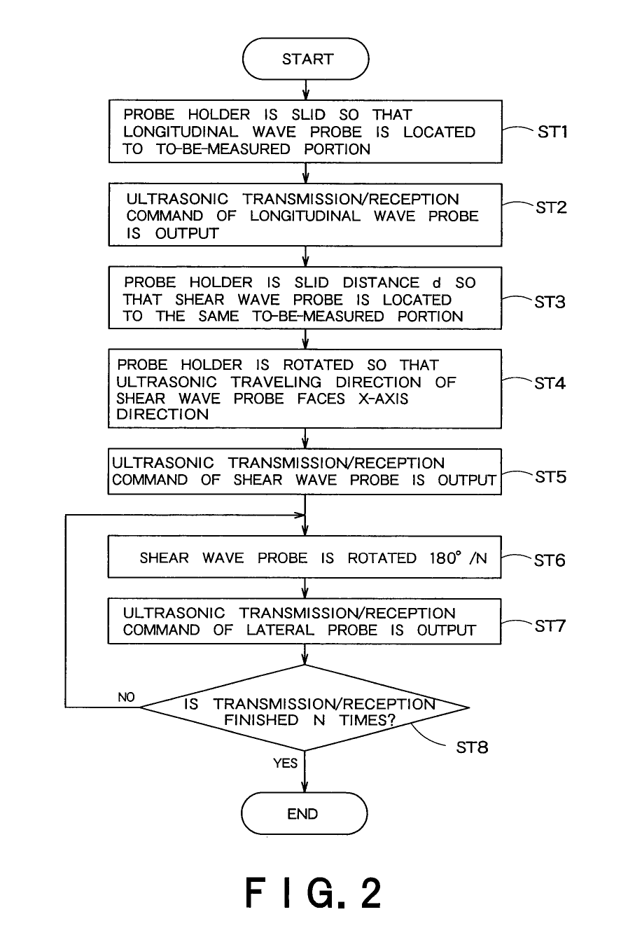

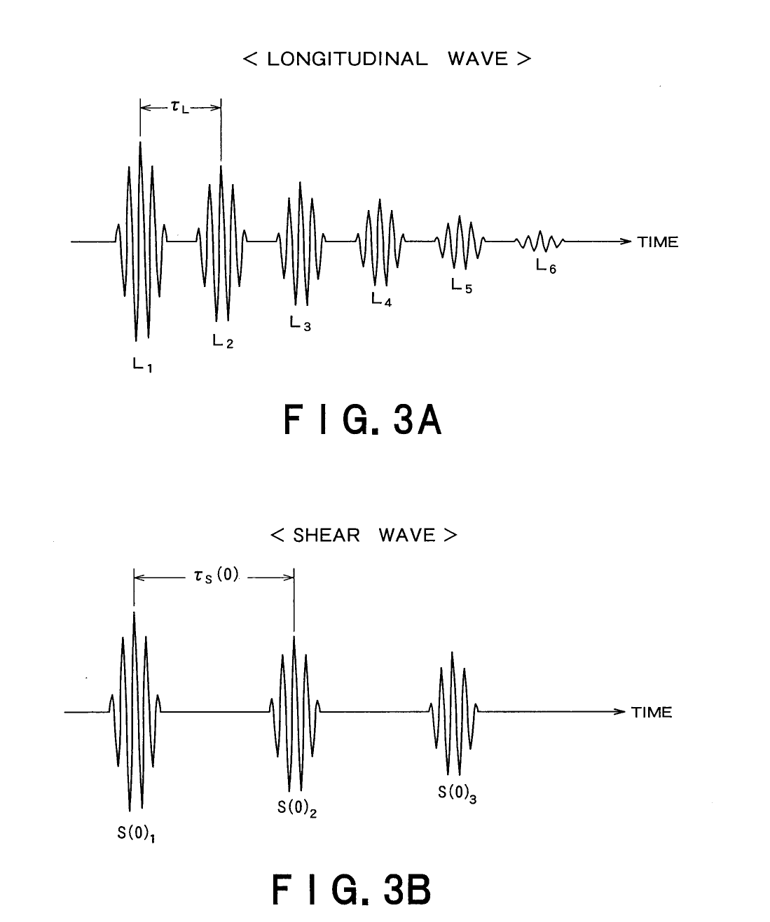

Next, in FIG. 1, operations of the respective components until the measured data analyzer 16 collects various types of data will be explained based on a flowchart of FIG. 2.

The probe control means 13 outputs a slide command to the slide drive unit 7 through the slide driver 9. With this operation, the slide drive unit 7 slides the probe holder 6 so that the longitudinal wave probe 1 is located at a to-be-measured position on the surface of the test piece M (step 1). The slide position detector 10 detects the sliding position data on the XY coordinate plane at the time and outputs it to the probe control means 13. The probe control means 13 outputs the input sliding position data to the measured data analyzer 16 as it is.

Then, after probe control means 13 switches the contact 14a of the probe switch 14 to the terminal a, it outputs an ultrasonic transmission/reception command to the ultrasonic transmission/reception circuit 15 (step 2). With this operation, the longitudinal wave probe 1 injects the injection pulse Pe to the interior of the test piece M and further outputs a signal of the reflection pulse Pr reflected on the bottom of the test piece M to the ultrasonic transmission/reception circuit 15 through the probe switch 14. The ultrasonic transmission/reception circuit 15 outputs the signal of the input reflection pulse Pr to the measured data analyzer 16 as echo data.

Next, the probe control means 13 outputs a slide command to the slide drive unit 7 through the slide driver 9 so that the probe holder 6 is slid in a horizontal direction a distance d along the surface of the test piece M (step 3). That is, the shear wave probe 3 is located at the same to-be-measured position, to which the longitudinal wave probe 1 injected the ultrasonic, this time. At the time, the sliding position data detected by the slide position detector 10 is output to the measured data analyzer 16 through the probe control means 13.

The probe control means 13 further outputs a rotation command to the rotation drive unit 8 through the rotation driver 11. With this operation, the rotation drive unit 8 rotates the probe holder 6 so that the ultrasonic traveling direction of the shear wave ultrasonic probe 3 faces the X-axis direction (step 4). At the time, the rotating position data detected by the rotating position detector 12 is output to the measured data analyzer 16 through the probe control means 13.

Then, after the probe control means 13 switches the contact 14a of the probe switch 14 to the terminal b, it outputs an ultrasonic transmission/reception command to the ultrasonic transmission/reception circuit 15 (step 5). With this operation, the shear wave probe 3 injects the injection pulse Pe along the X-axis direction and further outputs the signal of the reflection pulse Pr to the ultrasonic transmission/reception circuit 15 through the probe switch 14. The ultrasonic transmission/reception circuit 15 outputs the signal of the input reflection pulse Pr to the measured data analyzer 16 as echo data.

As described above, after the shear wave ultrasonic probe 3 carries out the transmitting/receiving operation while causing the ultrasonic traveling direction to face the X-axis direction, the probe control means 13 outputs a rotation command to the rotation drive unit 8 through the rotation driver 11 again. With this operation, the rotation drive unit 8 rotates the probe holder 6 so that the ultrasonic traveling direction of the shear wave probe 3 is set to a direction rotated 180°/N from the X-axis direction (step 6). At the time, the rotating position data detected by the rotating position detector 12 is output to the measured data analyzer 16 through the probe control means 13. It is assumed here that the value N is an integer of at least 2 and N=12 when the shear wave probe 3 is rotated, for example, each 15°.

Then, the probe control means 13 outputs an ultrasonic transmission/reception command to the ultrasonic transmission/reception circuit 15 in a state that the contact 14a of the probe switch 14 is kept to the terminal b side (step 7). With this operation, the shear wave probe 3 injects the injection pulse Pe along the direction rotated 360°/N from the X-axis direction and further outputs the signal of the reflection pulse Pr to the ultrasonic transmission/ reception circuit 15 through the probe switch 14. The ultrasonic transmission/reception circuit 15 outputs the signal of the input reflection pulse Pr to the measured data analyzer 16 as echo data.

After the shear wave probe 3 carries out the transmitting/receiving operation at the position where the ultrasonic traveling direction is set to the direction rotated 180°/N from the X-axis direction, the probe control means 13 determines whether or not the shear wave probe 3 has finished the transmitting/receiving operation N times (step 8).

When the shear wave probe 3 has not yet finished the transmitting/receiving operation N times, the process returns to step 6 at which the probe control means 13 rotates the probe holder 6 so that the shear wave probe 3 is located at a position which is further rotated (180°/N) from the previous ultrasonic injecting position, that is, the ultrasonic traveling direction of the shear wave probe 3 is set to a direction rotated (180°/N)·2 from the X-axis direction (step 6). Then, the probe control means 13 outputs an ultrasonic transmission/reception command to the ultrasonic transmission/ reception circuit 15 in a state that the contact 14a of the probe switch 14 is kept to the terminal b side likewise (step 7).

On the other hand, when the shear wave probe 3 has finished the transmitting/receiving operation N times, the probe control means 13 finishes all the processings at the time. Note that, in the above explanation, although the shear wave probe 3 carries out the transmitting/receiving operation after the longitudinal wave probe 1 caries out the transmitting/receiving operation, both the probes may carry out the transmitting/receiving operations in a reverse order.

Various types of measured data such as the echo data, the rotating position data, the sliding position data, and the like are collected to the measured data analyzer 16 by controlling the longitudinal and shear wave probes 1, 3 by the probe control means 13. Next, the analysis processing carried out to the measurement data by the measured data analyzer 16 will be explained.

A part (a) of FIG. 3 is a waveform view of the echo data detected by the longitudinal wave probe 1 and collected to the measured data analyzer 16. As shown in the figure, the echo data from the longitudinal wave probe 1 is composed of multiple echo (L1, L2, . . . , L6, . . . ) having a predetermined time interval, and the time interval is determined depending on the thickness D (m) of the test piece M.

When it is assumed here that the time interval between L1 echo and L2 echo is τ_{L} (sec), since the time interval τ_{L} is a time necessary for echo to reciprocate the thickness D of the test piece M, the sound velocity CL (m/sec) of the longitudinal wave in the test piece M can be calculated by following expression (3).

$${C}_{L} = \frac{2 D}{{τ}_{L}} ( m \text{/} sec ) \qquad ( 3 )$$

Various methods are proposed to measure the time interval τ_{L}. A sing-around method, an echo overlap method, and the like may be exemplified as the methods which have a relatively good time measuring accuracy and can be realized easily. These methods are disclosed in detail in “Basis and Application of Acoustic Elasticity” edited by Hidekazu Fukuoka, Optical recording medium Sha, April 1993.

The sing-around method is a method of measuring the overall time interval T (sec) between N pieces of ultrasonic pulses (L1, L2, . . . , LN) and calculating the time interval between the L1 echo and the L2 echo by the following expression (4). According to the method, the measuring accuracy of the time interval τ_{L} can be improved by using a lot of multiple echo.

$${τ}_{L} = \frac{T}{N - 1} ( sec ) \qquad ( 4 )$$

The echo overlap method is a method of measuring the time interval using the delay sweep function of an oscilloscope and the like. As a specific procedure, a delay time is changed by sequentially delaying the L1 echo so that the L1 echo overlaps the L2 echo. The delay time at the time the L1 echo completely overlaps the L2 echo is read and used as the time interval τ_{L}.

The measured data analyzer 16 determines a longitudinal wave sound velocity C_{L} by substituting the time interval τ_{L} determined as described above for the expression (3) and stores it. Note that, in the present invention, a general purpose method other than the above methods may be used as the method of measuring the time interval τ_{L} as long as it is a time measuring method having a good measuring accuracy.

A part (b) of FIG. 3 is a waveform view of echo data detected by the shear wave probe 3 and collected to the measured data analyzer 16 (the waveform is obtained based on the command at step 5 of FIG. 2, and the ultrasonic traveling direction thereof is the X-axis direction). As shown in the figure, the echo data from the longitudinal wave probe 1 is composed of multiple echo (S(0)₁, S(0)₂, S(0)₃, . . . ) having a predetermined time interval.

When the time interval between the S(0)₁ echo and the S(0)₂ echo is τ_{S}(0) (sec), since the time interval τ_{S}(0) is a time necessary for echo to reciprocate the thickness D (m) of the test piece M, the shear wave sound velocity τ_{S}(0) (m/sec) in the test piece M is calculated by the following expression (5).

$${V}_{S} ( 0 ) = \frac{2 D}{{τ}_{S} ( 0 )} ( m \text{/} sec ) \qquad ( 5 )$$

Note that since a shear wave sound velocity is about half a longitudinal wave sound velocity, the time interval τ_{S}(0) of the part (b) of FIG. 3 is about twice the time interval τ_{L} of the part (a) of FIG. 3.

Further, the measurement method of the time interval τ_{S}(0) is not limited to the methods such as a sing-around method, the echo overlap method, and the like, and a general purpose measuring method having a good measuring accuracy other than the above methods may be used likewise the case of the longitudinal wave.

Incidentally, when the probe holder 6 is rotated stepwise such that the ultrasonic traveling direction of the shear wave probe 3 is gradually apart from the X-axis direction at each rotation angle of 180°/N (for example, 15°) and an ultrasonic transmitting/receiving operation is carried out at each rotation angle, the waveform of echo data obtained by the series of transmitting/receiving operations is affected by the texture induced anisotropy of the test piece M.

The waveform of the series of (N-1) pieces of shear wave echo data obtained from the processing at steps 6, 7 of FIG. 2 is examined, and the time interval between the multiple echo obtained by the transmitting/receiving operation carried out at a first rotating position is shown by τ_{S}(I), and the shear wave sound velocity thereof is shown by V_{S}(I). At the time, a shear wave travels in a direction tilting (I×180/N)(degree) from the X-axis direction.

The acoustic velocities Vₛ(1), Vₛ(2), Vₛ(3), . . . Vₛ(I), . . . Vₛ(N-1) of the series of (N-1) pieces of the shear wave echo data can be determined by the following expression similar to the expression (5).

$${V}_{S} ( 1 ) = \frac{2 D}{{τ}_{S} ( 1 )}$$

$${V}_{S} ( 2 ) = \frac{2 D}{{τ}_{S} ( 2 )}$$

$${V}_{S} ( 3 ) = \frac{2 D}{{τ}_{S} ( 3 )}$$

$$…$$

$${V}_{S} ( I ) = \frac{2 D}{{τ}_{S} ( I )}$$

$$…$$

$${V}_{S} ( N - 1 ) = \frac{2 D}{{τ}_{S} ( N - 1 )}$$

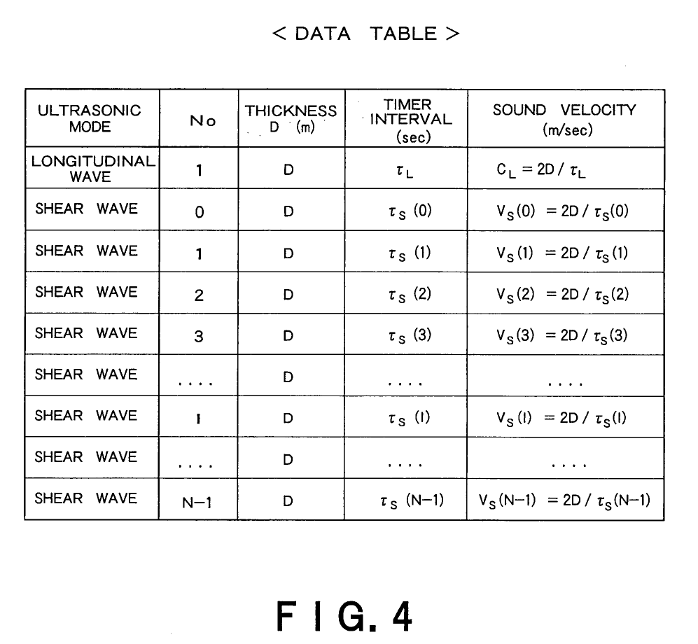

FIG. 4 is an explanatory views showing the contents of a data table in which the echo data of the longitudinal wave probe 1 obtained as described above, the time interval between the echo data at each rotation angle of the shear wave probe 3, and the sound velocity are summarized. The measured data analyzer 16 stores the contents of the data table to a storage unit thereof.

Next, a method of determining the texture induced anisotropy of the test piece M using the data table will be explained.

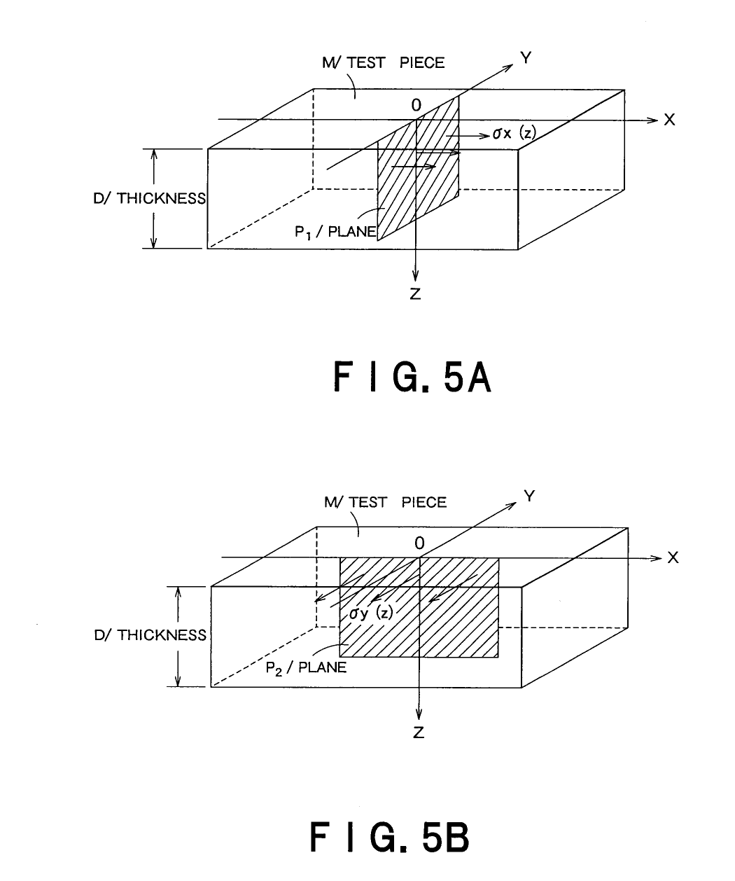

Parts (a) and (b) of FIG. 5 are explanatory views showing the test piece M and a three-dimensional coordinate set to it, wherein the part (a) is an explanatory view showing a plane P1 orthogonal to an X-axis by slanting lines, and the part (b) is an explanatory view showing a plane P2 orthogonal to a Y-axis by slanting lines.

In the part (a) of FIG. 5, when the residual stress acting on the plane p1 in the X-axis direction is shown by σₓ(z), since no external force acts on the plane P1, the following expression (6) is established from the balance of load on the plane P1
∫_{-D}^{p}σ_{X}(z)dydz=0 (6)

When the residual stress σₓ(z) is uniform in the Y-axis direction, the expression (6) is rewritten as an expression (7), and thus the following expression (8) is established.
∫_{-D}^{p}σ_{X}(z)dydz=dy∫_{-D}^{p}σ_{X}(z)dz=0 (7)
∫_{-D}^{p}σ_{X}(z)dz=0 (8)

According to “Latest Stress-Strain Measurement And Evaluation Technology” edited by Kozou Kawada, pp. 308-310, Published by Kabushiki Kaisha Sougou Gijutu Center, what is described below is found as to the longitudinal wave sound velocity. First, in the case of a tensile residual stress, the longitudinal wave sound velocity traveling in a direction orthogonal to a residual stress direction increases. Inversely, in the case of a compressional residual stress, the longitudinal wave sound velocity traveling in the direction orthogonal to the residual stress direction decreases. Accordingly, these residual stresses are shown by an expression (8). Since the effects of the residual stresses are cancelled, it can be considered that the sound velocity of the longitudinal wave traveling in the test piece M is less changed by the residual stress and shows an average sound velocity.

Further, according to “Latest Stress-Strain Measurement And Evaluation Technology” edited by Kozou Kawada, pp. 308-310, Published by Kabushiki Kaisha Sougou Gijutu Center, what is described below is found also as to the shear wave sound velocity likewise the longitudinal wave sound velocity. That is, when the vibrating direction of a shear wave is the same as a stress direction, in the case of a compression stress, the shear wave sound velocity increases, and, in the case of a tensile stress, the shear wave sound velocity decreases. Accordingly, since these residual stresses are shown by the expression (8) and the effects of the residual stresses are cancelled, it can be considered that the sound velocity of a shear wave traveling in the test piece M is less changed by the residual stress. That is, it can be considered that Vs(0) is not also affected by the residual stress in the X-axis direction likewise the longitudinal wave sound velocity and affected only by texture induced anisotropy.

It is possible to consider likewise also as to the residual stress in the Y-axis direction. That is, in the part (b) of FIG. 5, when residual stress acting on the plane P2 in the Y-axis direction is shown by σ_{Y}(z), since no external force acts on the plane P2, the following expression (9) is established from the balance of load on the plane P2.
∫_{-D}^{p}σ_{Y}(z)dxdz=0 (9)

When σy(z) is uniform in the X-axis direction, the expression (9) can be rewritten as an expression (10), and thus an expression (11) is established.
∫_{-D}^{p}σ_{Y}(z)dxdz=dx∫_{-D}^{p}σ_{Y}(z)dz=0 (10)
∫_{-D}^{p}σ_{Y}(z)dz=0 (11)

Accordingly, it can be considered likewise the case of the Y-axis direction that the sound velocity Vₛ(I) of a shear wave vibrating in the Y-axis direction is the sound velocity of a shear wave which is not affected by the residual stress in the Y-axis direction and affected only by texture induced anisotropy.

Accordingly, the texture induced anisotropy ought to be defined when it is possible to calculate the sound velocity of an SAW by any method using the longitudinal wave sound velocity and the shear wave sound velocity which are unlike to be affected by these residual stresses.

That is, the constant (α_{R}(0), (α_{R}(90)) of the texture induced anisotropy, which affects the sound velocities of SAW traveling in the X-axis direction (0° direction) and the Y-axis direction (90° direction), are less affected by residual stresses σₓ, σ_{y}, they can be rewritten as shown below assuming σₓ=σ_{y}=0.

$$\begin{matrix}{α}_{r} ( 0 ) = \frac{{\overline{V}}_{R} ( 0 ) - {V}_{R}^{0}}{{V}_{R}^{0}} & ( 12 ) \\ {α}_{R} ( 90 ) = \frac{{\overline{V}}_{R} ( 90 ) - {V}_{R}^{0}}{{V}_{R}^{0}} & ( 13 )\end{matrix}$$

In the above expressions (12) and (13), V̅_{R}(0) is the sound velocity of an SAW which does not include the effect of residual stress induced anisotropy and travels in the X-axis direction, V̅_{R}(90) is the sound velocity of an SAW which does not include residual stress induced anisotropy and travels in the Y-axis direction, and V_{R}⁰ is the sound velocity of an SAW in an isotropic body which includes neither residual stress induced anisotropy nor texture induced anisotropy. Several methods are considered as methods of determining V̅_{R}(0), V̅_{R}(90), and V_{R}⁰ as described below. These methods will be sequentially explained below.

First, a first method will be explained. According to B. A Auld: Acoustic Fields and Waves in Solid, Volume 11, PP. 88-94, Krieger Publishing Company, Florida, the sound velocity V_{R} of an SAW can be generally determined as a solution of the following hexanary equation (14) using the sound velocity C_{L} of a longitudinal wave and the sound velocity Vₛ of a shear wave.

$${( \frac{{V}_{R}}{{V}_{S}} )}^{6} - 8 {( \frac{{V}_{R}}{{V}_{S}} )}^{4} + 8 [ 3 - 2 {( \frac{{V}_{S}}{{C}_{L}} )}^{2} ] {( \frac{{V}_{R}}{{V}_{S}} )}^{2} - 16 [ 1 - {( \frac{{V}_{S}}{{C}_{L}} )}^{2} ] = 0 \qquad ( 14 )$$

Since the measured data shown in the data table of FIG. 4 is the sound velocities of the longitudinal and shear waves which are less affected by residual stress induced anisotropy, V̅_{R}(0) and V̅_{R}_{_{—}}(90) can be calculated as the solutions of the following equations (15) and (16) using these data.

$$\begin{matrix}{( \frac{{\overline{V}}_{R} ( 0 )}{{V}_{S} ( 0 )} )}^{6} - 8 {( \frac{{\overline{V}}_{R} ( 0 )}{{V}_{S} ( 0 )} )}^{4} + 8 [ 3 - 2 {( \frac{{V}_{S} ( 0 )}{{C}_{L}} )}^{2} ] {( \frac{{\overline{V}}_{R} ( 0 )}{{V}_{S} ( 0 )} )}^{2} - 16 [ 1 - {( \frac{{V}_{S} ( 0 )}{{C}_{L}} )}^{2} ] = 0 & ( 15 ) \\ {( \frac{{\overline{V}}_{R} ( 90 )}{{V}_{S} ( 90 )} )}^{6} - 8 {( \frac{ {\overline{V}}_{ R} ( 90 )}{ {V}_{S} ( 90 )} )}^{4} + 8 [ 3 - 2 {( \frac{{V}_{S} ( 90 )}{{C}_{L}} )}^{2} ] {( \frac{{\overline{V}}_{R} ( 90 )}{{V}_{S} ( 90 )} )}^{2} - 16 [ 1 - {( \frac{{V}_{S} ( 90 )}{{C}_{L}} )}^{2} ] = 0 & ( 16 )\end{matrix}$$

Further, since the following expression (17) is also established, V_{R}(I) can be calculated by solving the expression (17).

$${( \frac{{\overline{V}}_{R} ( I )}{{V}_{S} ( I )} )}^{6} - 8 {( \frac{{\overline{V}}_{R} ( I )}{{V}_{S} ( I )} )}^{4} + 8 [ 3 - 2 {( \frac{{V}_{S} ( I )}{{C}_{L}} )}^{2} ] {( \frac{{\overline{V}}_{R} ( I )}{{V}_{S} ( I )} )}^{2} - 16 [ 1 - {( \frac{{V}_{S} ( I )}{{C}_{L} ( I )} )}^{2} ] = 0 \qquad ( 17 )$$

The sound velocity of the SAW in the isotropic body can be approximated as described below using the expression (18) from a result of the calculation.

$${V}_{R}^{0} = \frac{1}{N} {\sum }_{i = 0}^{N - 1} {\overline{V}}_{R} ( i ) \qquad ( 18 )$$

The measured data analyzer 16 can calculate the constant of texture induced anisotropy by carrying out processing as described above using the equations (12) and (13).

Next, a second method will be explained. According to B. A Auld: Acoustic Fields and Waves in Solid, Volume 11, PP. 88-94, Krieger Publishing Company, Florida, the ratio of the sound velocity V_{R} of an SAW and the sound velocity V_{S} of a shear wave can be shown by a Poisson's ratio a as shown in the left expression of the following expressions (19), and the Poisson's ratio σ can be shown by the sound velocity V_{S} of the shear wave and the sound velocity C_{L} of the longitudinal wave as shown in the right expression of the following expressions (19).

$$\frac{{V}_{R}}{{V}_{S}} = \frac{0.87 + 1.12 σ}{1 + σ} , σ = \frac{1 - 2 ( \frac{{V}_{S}}{{C}_{L}} )}{2 ( 1 - {[ \frac{{V}_{S}}{{C}_{L}} ]}^{2} )} \qquad ( 19 )$$

Accordingly, the sound velocities V̅_{R}(0), V̅_{R}(90) of the SAW in the X-axis and Y-axis directions can be calculates by applying the expressions (19) as shown below.

$$\begin{matrix}\frac{{\overline{V}}_{R} ( 0 )}{{V}_{S} ( 0 )} = \frac{0.87 + 1.12 σ}{1 + σ} , σ = \frac{1 - 2 {( \frac{{V}_{S} ( 0 )}{{C}_{L}} )}^{2}}{2 ( 1 - {[ \frac{{V}_{S} ( 0 )}{{C}_{L}} ]}^{2} )} & ( 20 ) \\ \frac{{\overline{V}}_{R} ( 90 )}{{V}_{S} ( 90 )} = \frac{0.87 + 1.12 σ}{1 + σ} , σ = \frac{1 - 2 {( \frac{{V}_{S} ( 90 )}{{C}_{L}} )}^{2}}{2 ( 1 - {[ \frac{{V}_{S} ( 90 )}{{C}_{L}} ]}^{2} )} & ( 21 ) \\ {V}_{R}^{0} = \frac{1}{N} {\sum }_{i = 0}^{N - 1} {\overline{V}}_{R} ( i ) & ( 22 ) \\ \frac{{\overline{V}}_{R} ( I )}{{V}_{S} ( I )} = \frac{0.87 + 1.12 σ}{1 + σ} , σ = \frac{1 - 2 {( \frac{{V}_{S} ( I )}{{C}_{L}} )}^{2}}{2 ( 1 - {[ \frac{{V}_{S} ( I )}{{C}_{L}} ]}^{2} )} & ( 23 )\end{matrix}$$

The constant of texture induced anisotropy can be calculated using these equations (20) to (23) and (12), (13).

Next, a third method will be explained. The sound velocities V̅_{R}(0), V̅_{R}(90) of the SAW in the X-axis and Y-axis directions can be determined by the first or second method. Then, the sound velocity V_{R}⁰ of an SAW in an isotropic body can be approximated by calculating the average value of the sound velocities V̅_{R}(0), V̅_{R}(90) of the SAW as shown by the following expression (24). Accordingly, the constant of texture induced anisotropy can be calculated by substituting the determined value for the equations (12), (13).

$${V}_{R}^{0} = \frac{{\overline{V}}_{R} ( 0 ) + {\overline{V}}_{R} ( 90 )}{2} \qquad ( 24 )$$

Next, a fourth method will be explained. The sound velocity of an SAW around a portion of the test piece M where the texture induced anisotropy thereof is measured can be actually measured previously. The sound velocity of the SAW obtained by the actual measurement is shown by V_{R}′(I). Accordingly, the sound velocity V_{R}⁰ of the SAW in the isotropic body can be determined by rotating the shear wave probe 3 N times of at each rotation angle of 180°/N from the X-axis and calculating N pieces of data at rotating position after each rotation V_{R}′(I) as shown by an expression (25). The constant of texture induced anisotropy can be calculated by substituting the determined value to the expressions (12), (13).

$${V}_{R}^{0} = \frac{1}{N} {\sum }_{i = 0}^{N - 1} {V}_{R}^{′} ( I ) \qquad ( 25 )$$

Next, a fifth method will be explained. As described in the fourth method, the sound velocity of an SAW around a portion of the test piece M where texture induced anisotropy is measured can be actually measured previously. Accordingly, it is also possible to measure the sound velocity V_{R}′(0) of an SAW traveling in the X-axis direction and the sound velocity V_{R}′(90) of an SAW traveling in the Y-axis direction. Then, the sound velocity V_{R}⁰ of an SAW can be approximately determined by calculating the average value of the two actually measured data as shown in the following expression (26). The constant of texture induced anisotropy can be calculated by substituting the determined value to the expressions (12), (13).

$${V}_{R}^{0} = \frac{{V}_{R}^{′} ( 0 ) + {V}_{R}^{′} ( 90 )}{2} \qquad ( 26 )$$

As described above, according to the arrangement of FIG. 1, in measured data analyzing means 16, various types of measured data such as echo data, rotating position data, sliding position data, and the like can be collected by controlling the longitudinal and shear wave probes 1, 3 by the probe control means 13, and the constant of texture induced anisotropy, which cannot be conventionally determined, can be determined by analyzing the collected measured data. Accordingly, the residual stress of the test piece M, that is, the stress measurement material can be accurately calculated based on the determined constant of texture induced anisotropy.

What is claimed is:

1. An ultrasonic stress measuring apparatus comprising:
a longitudinal wave probe and a shear wave probe which can be disposed on a surface of a stress measurement material;
a probe drive mechanism capable of moving or rotating both the probes along the surface of the material;
probe control means for causing one of both the probes to carry out an ultrasonic transmitting/receiving operation to a to-be-measured portion of the material, thereafter switching the disposition of one of the probes and that of the other thereof by controlling the movement of the probe drive mechanism and causing the other probe to carry out an ultrasonic transmitting/receiving operation to the same to-be-measured portion, and, in particular rotating the shear wave probe N times at each rotation angle of 180°/N (N: integer of at least 2) so that the shear wave probe carries out the transmitting/receiving operation at each rotating position; and
measured data analyzing means for determining the constant of texture induced anisotropy from the sound velocity data of the SAW obtained from the transmitting/receiving operations of both the probes and calculating the residual stress of the stress measurement material based on the determined constant.

2. An ultrasonic stress measuring apparatus according to claim 1, wherein the sound velocity data of the SAW is:
the sound velocity data of an SAW traveling in an X-axis direction without being affected by surface residual stress induced anisotropy;
the sound velocity data of an SAW traveling in a Y-axis direction vertical to the X-axis direction without being affected by the surface residual stress induced anisotropy; and
the sound velocity data of an SAW in an isotropic body which is not affected by any of surface residual stress induced anisotropy and texture induced anisotropy.

3. An ultrasonic stress measuring apparatus according to claim 2, wherein:
the sound velocity data of the SAW traveling in the X-axis and Y-axis directions, respectively, is determined as the solution of a predetermined hexanary SAW sound velocity equation shown using the longitudinal wave sound velocity and the acoustic velocities of shear waves in the X-axis and Y-axis directions; and
the sound velocity data of the SAW in the isotropic body, which is not affected by any of the surface residual stress induced anisotropy and the texture induced anisotropy, is determined by calculating the average value of the sound velocity data of N pieces SAW determined as the solution of a predetermined hexanary surface acoustic wave sound velocity equation shown using the sound velocity of the longitudinal wave and the sound velocity of the shear wave in an ultrasonic traveling direction at the rotating position after the shear wave probe is rotated N times.

4. An ultrasonic stress measuring apparatus according to claim 2, wherein:
the sound velocity data of the SAW traveling in the X-axis and Y-axis directions, respectively, are determined from a predetermined equation in which the ratio of the sound velocities of the SAW in the X-axis and Y-axis directions and the sound velocities of the shear waves in the X-axis and Y-axis directions is shown by a Poisson ratio; and
the sound velocity data of the SAW in the isotropic body, which is not affected by any of the surface residual stress induced anisotropy and the texture induced anisotropy, is determined by calculating the average value of the sound velocity data of N pieces of SAW determined from a predetermined equation in which the sound velocity of an SAW in an ultrasonic traveling direction at the rotating position of the shear wave probe after it is rotated N times and the sound velocity of a shear wave in the same direction by a Poisson's ratio.

5. An ultrasonic stress measuring apparatus according to claim 2, wherein the sound velocity data of an SAW in an isotropic body, which is not affected by any of the surface residual stress induced anisotropy and the texture induced anisotropy, is determined by calculating the average value of two data, that is, the sound velocity data of the SAW traveling in the X-axis direction without being affected by the surface residual stress induced anisotropy and the sound velocity data of the SAW traveling in the Y-axis direction vertical to the X-axis direction without being affected by the surface residual stress induced anisotropy.

6. An ultrasonic stress measuring apparatus according to claim 2, wherein the sound velocity data of the SAW in the isotropic body, which is not affected by any of the surface residual stress induced anisotropy and the texture induced anisotropy, is determined by previously obtaining by actually measuring the sound velocity data of N pieces of SAW in an ultrasonic traveling direction at the rotating position of the shear wave probe after it is rotated N times and calculating the average value of the obtained N pieces of data.

7. An ultrasonic stress measuring apparatus according to claim 2, wherein the sound velocity data of the SAW of the isotropic body, which is not affected by any of the surface residual stress induced anisotropy and the texture induced anisotropy, is determined by actually measuring two data, that is, the sound velocity data of the SAW traveling in the X-axis direction without being affected by the surface residual stress induced anisotropy and the sound velocity data of the SAW traveling in the Y-axis direction vertical to the X-axis direction without being affected by the surface residual stress induced anisotropy previously and calculating the average value of the two obtained data.
